(19) United States
(12) Patent Application Publication
(10) Pub. No.: US 2022/0276109 A1
(43) Pub. Date: Sep. 1, 2022

(54) TIRE PRESSURE MONITORING SYSTEM WITH ACOUSTIC SENSOR

(71) Applicant: Nexen Tire America, Inc., Diamond Bar, CA (US)

(72) Inventor: Aaron Neumann, Hudson, OH (US)

(21) Appl. No.: 17/748,193

(22) Filed: May 19, 2022

Related U.S. Application Data
(63) Continuation-in-part of application No. 16/271,009, filed on Feb. 8, 2019.
(60) Provisional application No. 62/627,983, filed on Feb. 8, 2018.

(51) Int. Cl. G01L 17/00; H04R 19/04; H04R 1/08; H04R 3/00; B60C 23/04; B60C 11/24

(52) U.S. Cl. CPC G01L 17/00; H04R 19/04; H04R 1/08; H04R 3/00; B60C 23/0486; B60C 11/243; H04R 2201/003

(57) ABSTRACT

An at least one acoustic sensor in form of a microphone configured for coupling with a tire pressure monitoring system and tire pressure monitoring system unit sensor to generally detect an acoustic signal within a tire interior space generated by a tire as the tire travels across a road surface. The detected signal can be used by various vehicle systems to generally determine a tire condition, such as, but not limited to, tread wear, tread depth, tire health, road condition, road characterization, status of noise reducing foam, and active noise cancelling.

### CROSS REFERENCE TO RELATED APPLICATIONS

This U.S. Patent Application is a continuation in part to U.S. patent application Ser. No. 16/271,009 filed 8 Feb. 2019, which claims priority to U.S. Provisional Patent Application No. 62/627,983 filed 8 Feb. 2018, each of which the disclosure is considered part of the disclosure of this application and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present invention relates generally to a tire pressure monitoring system coupled to a sensor configured to monitor an acoustic signal generated by a tire as it contacts a road surface for indicating a condition of the tire or the road surface. More particularly, the present invention relates to an acoustic sensor positioned on a generally standard tire pressure monitoring system sensor and placed within a tire of a vehicle for monitoring the tire, including but not limited to, tire wear, overall tire health, and various tire tread and road conditions.

### SUMMARY OF THE INVENTION

The device of the present disclosure relates generally to an improved tire pressure monitoring apparatus, system, and method for use in the detection and measurement of an acoustic signal generated by a tire as it contacts a road surface to indicate a wear condition. The system and apparatus of the disclosure is generally coupled with a Tire Pressure Monitoring System (“TPMS”) sensor unit that is mounted on a wheel of vehicle and is configured to detect and measure an acoustic signal generated by the tread of the tire as it contacts the road surface in addition to the standard pressure sensor apparatus of the TPMS sensor unit. The sensed and measured acoustic signal can be utilized by various systems of the vehicle, including, but not limited to, the TPMS, to generally detect and alert to various conditions including, but not limited to, tread wear, tread depth, tire health, road condition, road characterization, status of noise reducing foam, and active noise cancelling.

Alternately the acoustic signal can be configured to detect and sense a vibration signal for use by various vehicle systems. Still alternately, the sensed vibration and the sensed acoustic signal are utilized in combination by various systems of the vehicle, including, but not limited to, the TPMS, to generally detect and alert to various conditions including, but not limited to, tread wear, tread depth, tire health, road condition, road characterization, status of noise reducing foam, and active noise cancelling.

The acoustic sensor apparatus of the present disclosure is generally positioned on the TPMS unit sensor circuit board positioned within an interior area of a tire and within the case of the TPMS unit sensor.

In an alternate embodiment, the acoustic sensor apparatus of the present disclosure can generally be configured in a coupling with the TPMS unit and positioned between the wheel and the TPMS unit within the interior area of the tire.

In yet an additional alternate embodiment, the acoustic sensor apparatus of the present disclosure can generally be positioned in a coupling with the TPMS unit and positioned adjacent to a valve stem at an exterior area of the wheel and not within the tire interior.

In an additional and alternate embodiment, the acoustic sensor apparatus of the device integrated with the TPMS unit may include a plurality of sensors positioned in multiple locations near the tire to be monitored, including, but not limited to, positions interior to the tire, interior to the wheel, exterior to the wheel, and exterior to the tire to detect the acoustic signal.

In an alternate embodiment, the apparatus of the present disclosure may utilize an additional sensor or sensors configured to detect and measure a vibration signal or alternately may utilize a sensor adapted to detect both an acoustic signal and a vibration signal.

In an alternate embodiment of the present disclosure, the apparatus may utilize a sensor coupled to the TPMS unit for detecting an acoustic signal in combination with a pressure sensor. Alternately, this sensor may include the ability to detect a vibration signal in addition to an acoustic signal and a pressure signal.

In an alternate embodiment of the present disclosure, the apparatus may utilize an acoustic sensor within the TPMS sensor unit that is separate from the pressure sensor. Alternately, this separate sensor may include the ability to detect both an acoustic signal and a vibration signal.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with the accompanying drawings, and wherein:

FIG. 1 is a side view of the apparatus, according to the present disclosure;

FIG. 2 is a wireframe diagram of the systems of the apparatus with separate pressure and acoustic sensors, according to the present disclosure;

FIG. 3 is a wireframe diagram of the systems of the apparatus with combined pressure and acoustic sensors, according to the present disclosure;

FIG. 4 is a view of a tire with simulated wear pattern configured to generate a detected noise corresponding to a wear condition, according to the present disclosure;

FIG. 5 is an exemplar color spectral chart of a detected noise at a given frequency, according to the present disclosure;

FIG. 6 is an exemplar time averaged spectral chart of detected noise at a given frequency, according to the present disclosure;

FIG. 7 is a view of the apparatus within the interior space of a tire, according to the present disclosure;

FIG. 8 is an external view of a case of the apparatus, according to the present disclosure;

FIG. 9 is an interior view of the case of the apparatus and the exemplary circuit board for the apparatus, according to the present disclosure; and

FIG. 10 is an interior reverse view of the case and apparatus, according to the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the FIGS., with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Such joining may allow for the transfer of fluids, gasses, and plasma or the flow of electricity or electrical signals.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

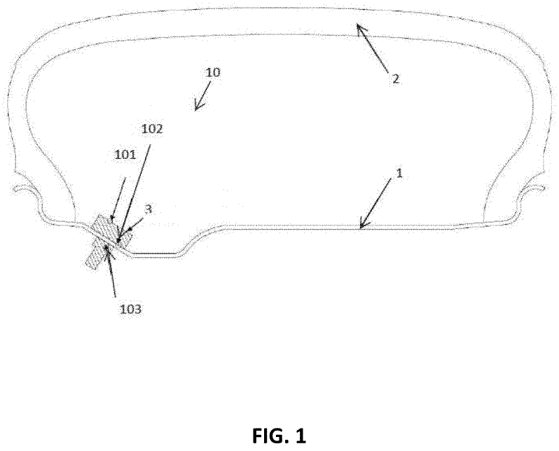

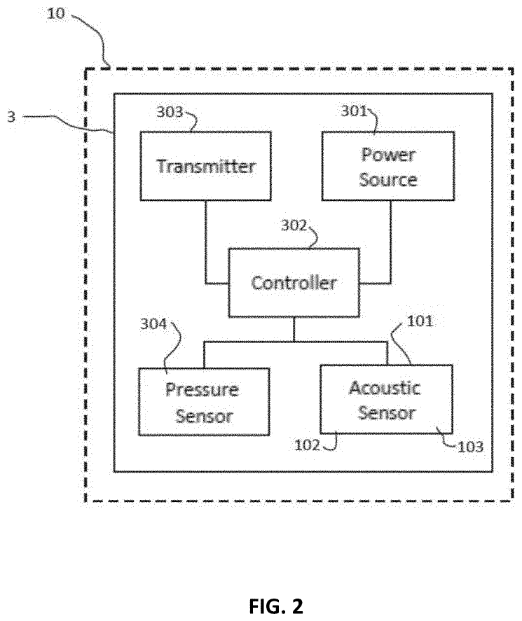

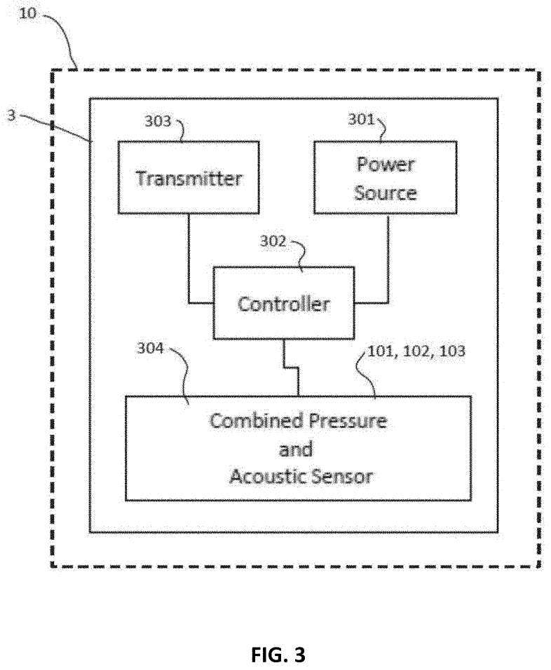

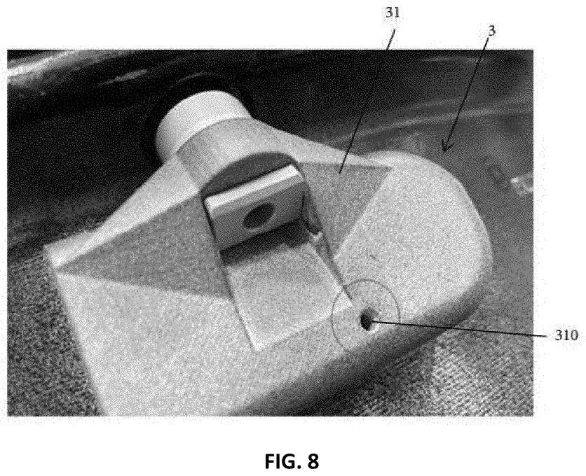

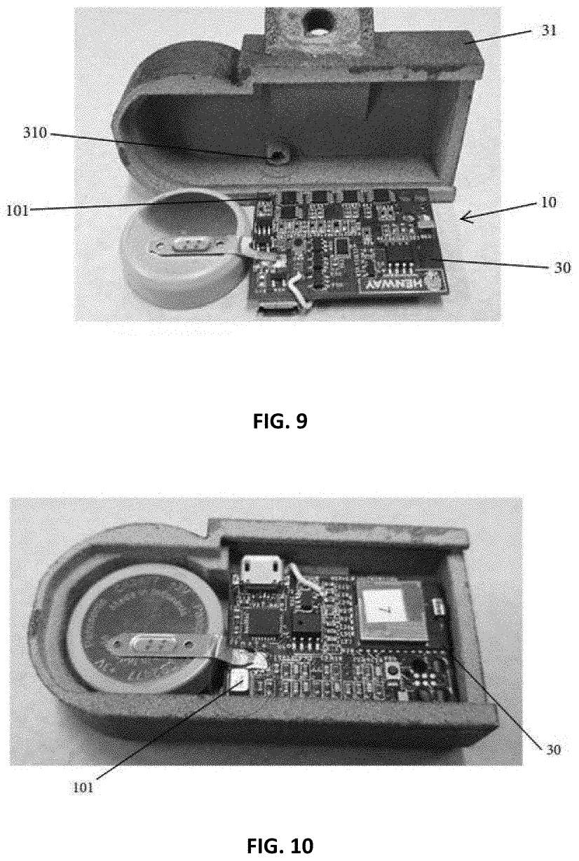

Referring now to FIGS. 1-10, an apparatus, system, and method are disclosed for detecting and measuring an acoustic signal in a coupling with a vehicle Tire Pressure Monitoring System (“TPMS”) for use in determining certain conditions related to a tire positioned on the vehicle as it contacts a road surface. The detected acoustic signal can be measured and further processed and utilized by various vehicle systems to determine various conditions including, but not limited to, tread wear, tread depth, tire health, road condition, road characterization, status of noise reducing foam, and active noise cancelling.

The system 10 of the present disclosure is generally adapted for coupling with a TPMS unit sensor 3 within a vehicle. At least one sensor 101 of the system 10 is configured for placement within an interior of a wheel 1 and within an interior of a tire 2 mounted on the wheel 1 and positioned on the vehicle in a coupling with the TPMS unit sensor 3. The at least one sensor 101 configured to detect an acoustic signal generated by the tire 2 as it contacts a road surface. The at least one sensor 101 generally comprised of a microphone configured to measure a noise at level in a range of 50 to 140 decibel (dB) and at frequencies in a range of 1 to 2,500 hertz (Hz).

Accordingly, the at least one sensor 101 is configured to detect and measure a given noise at a given volume and given frequency corresponding to a specific pattern, wherein this pattern can be predetermined and created within a given tire to indicate a specific wear pattern or condition. Preferably, this specific wear pattern is specifically created and formed to be applicable across multiple conditions a given tire will encounter, such as various speeds, pavement types, and road conditions.

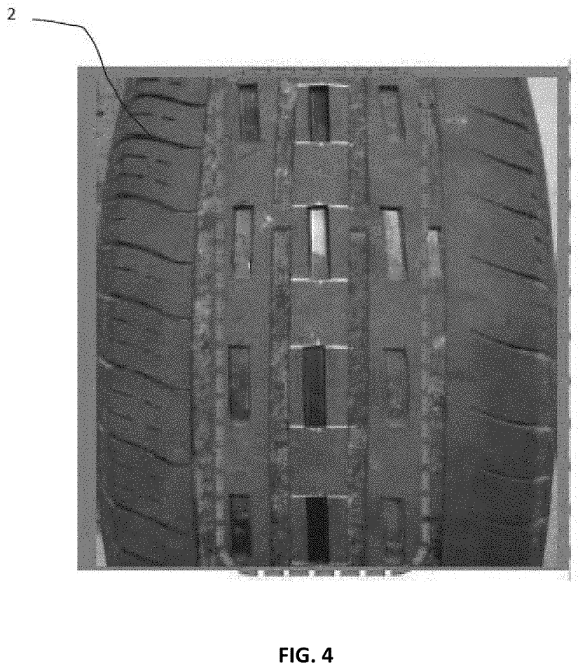

Within research and development related to the present disclosure several types of road surfaces and wear patterns were tested to ensure veracity of the system 10 with the at least one sensor 101 actively measuring tire noise during driving. In a series of experimental tests, several tires were configured with various hand cut sections, generally rectangular in shape, and placed along inner intermediate, outer intermediate, and center intermediate ribs to simulate a wear condition. These hand cut sections were generally provided in a range of sizes and locations, placed on a vehicle, and driven across a variety of road surfaces at various ascending and descending speeds. During driving, the at least one sensor 101 was utilized to detect and measure tire noise across the noise and frequency range. Based upon experimentation and analysis the at least one sensor 101 was able to detect and measure the presence of the hand cut sections on all road surfaces at a speed of forty-five miles per hour (45 mph) when thirty-two (32) cut sections were provided in three equally spaced rows in the outer intermediate, center intermediate, and inner intermediate ribs across the tire width and equally spaced around the tire circumference (FIG. 4). The preferred dimension of the hand cut section was thirty-six by ten by three millimeters (36 mm×10 mm×3 mm).

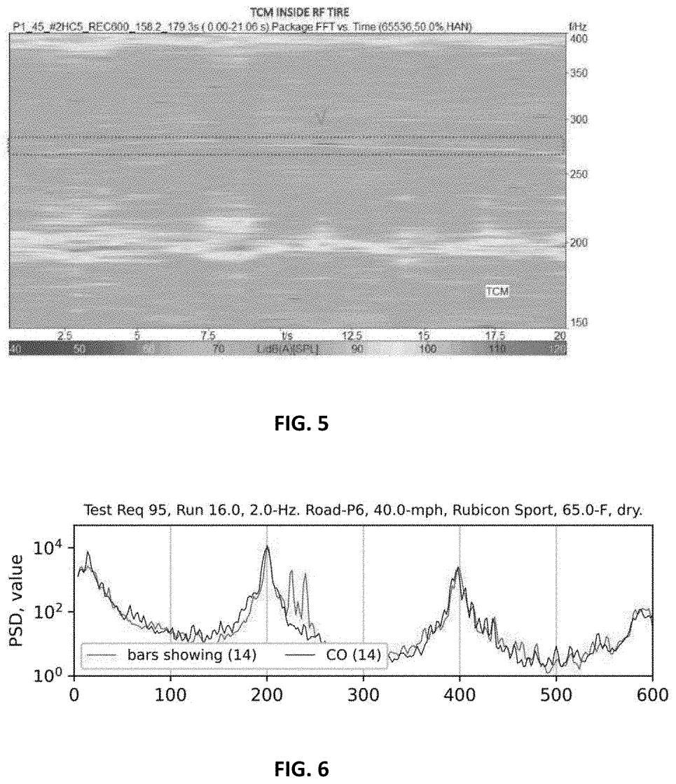

Based upon these experimental tests, the first sensor 101 detected signal can be processed by the system 10 with the detected noise and frequency generally plotted on a time averaged spectral chart for indication of a worn tire condition. Accordingly, a pair of such charts are shown in FIG. 5-6. Referring now to FIG. 5-6, a time averaged spectral chart is shown. These charts show the detected worn tire signal on an asphalt chip pavement at a constant speed of forty-five miles per hour (45 mph). As is seen, a clear signal corresponding to the noise of the cut sections is detected at a frequency within a range between two hundred and fifty hertz (250 Hz) and three hundred hertz (300 Hz). Generally, across multiple pavement surfaces and speeds the detected range is between two hundred and fifty hertz (250 Hz) and three hundred and hertz (350 Hz).

Alternate to an acoustic sensor, the at least one sensor 101 can be configured to detect a signal corresponding to a vibration or pattern of vibrations of the tire 2 or the wheel 1 as it contacts the road surface. Further to increase the veracity of detection the at least one sensor 101 of the system 10 can be configured to detect both an acoustic signal and a vibration signal. Accordingly, each of the vibration signal or the acoustic signal or both the acoustic signal and vibration signal of the at least one sensor 101 detected and processed by the system 10 to determine a given condition of the tire 2 during operation on a road surface.

The system 10 and method for use may alternately include a second sensor 102. The second sensor 102 generally integrated with the TPMS unit sensor 3 and configured for positioning between the wheel 1 and TPMS unit sensor 3 within an interior of the wheel 1 and the tire 2. The second sensor 102 when utilized is configured to operate in tandem with the at least one sensor 101, wherein the second sensor 102 is configured to detect an acoustic signal generated by the tread of the tire 2 as it contacts the road surface. Similar to the at least one sensor 101, the second sensor 102 can be configured and equipped to detect a signal corresponding to the vibration of the tire 2 or the wheel 1. Further, the second sensor 102 of the system 10 can be configured to detect both an acoustic signal and a vibration signal.

The system 10 and method for use may include a third sensor 103. The third sensor 103 generally integrated with the TPMS unit sensor 3 and configured for positioning exterior to the wheel 1 and exterior to the tire 2. The third sensor 103, when utilized, configured to operate in tandem with the at least one sensor 101 and the second sensor 102, wherein the third sensor 103 is configured to detect an acoustic signal generated by a tread of the tire 2 as it contacts the road surface. Similar to the at least one sensor 101 and the second sensor 102, the third sensor 103 can be configured to detect a signal corresponding to the vibration of the tire 2 or the wheel 1. Further, the third sensor 103 of the system 10 can be configured to detect both an acoustic signal and a vibration signal.

The system 10 of the present disclosure may use all of the sensors 101-103 or may only use a signal sensor 101-103 of the sensors 101-103 or a pair of sensors 101-103 of the sensors 101-103. Still further, the system 10 and associated apparatuses and methods for their use may use additional sensors in various additional locations within the TPMS unit sensor 3 without departing from the spirit and the scope of the disclosure. Further, the system 10 may utilize additional and existing sensors present with the vehicle the system 10 is used within.

The system 10 and sensors 101-103 of the present disclosure are generally configured for placement and integration within the TPMS system and the TPMS unit sensor 3 within the tire 2 interior of a vehicle, wherein the sensors 101-103 are configured to detect a signal and process this signal through the individual TPMS sensor unit 3 within a given tire 2 interior space. Accordingly, the sensors 101-103 are coupled to a power supply 301, a controller 302, a transmitter 303, and a pressure sensor 304 within the TPMS sensor unit 3. The sensors 101-103 may be provided and positioned at a location separate from the pressure sensor 304 while maintaining a coupling within the TPMS sensor unit 3 or may be integrated directly into the TPMS sensor unit 3 with the pressure sensor 304, wherein the sensors 101-103, 304 are utilized to detect pressure, an acoustic signal, and, if desired, configured to detect a vibration signal.

The controller 302 configured to direct and control the features of the system 10 and including a microprocessor. The controller 302 configured to utilize detected sensor 304, 101-103, signals and measurement data in a computation, wherein detected data is received by the controller 302 in a data stream where the detected data is refined, calculated, and processed to generate a command and communicate this command via the transmitter 303 to the vehicle for notification to additional vehicle systems and to an operator of the vehicle.

The sensors 101-103 and integration into the TPMS system are generally configured to detect a signal for use and receipt by the TPMS system or other vehicle systems for generally notifying, alerting, and using the signal for additional processes. These processes may include, but not be limited to, the amount of tread depth remaining on a tire, and for use in active noise cancelling within the vehicle.

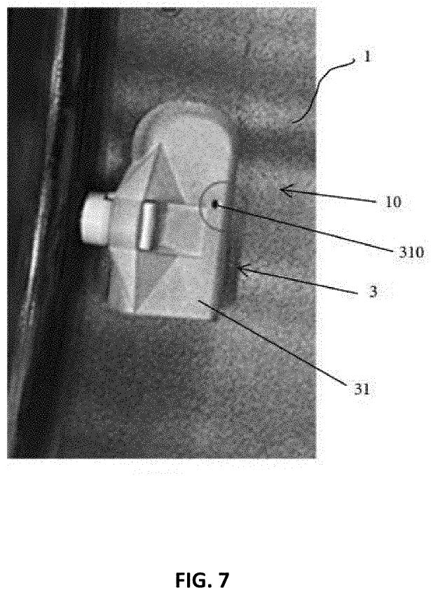

Referring now specifically to FIGS. 7-10, the at least one sensor 101 of the system 10 is shown integrated directly upon a circuit board 30 of the TPMS unit sensor 3 configured for placement within an interior of the wheel 1 and within an interior of the tire 2 mounted on the wheel 1 and positioned on the vehicle in a coupling with the TPMS system. The at least one sensor 101 is configured to detect an acoustic signal generated by the tire 2 as it contacts a road surface. The at least one sensor 101 generally comprised of a microphone configured to measure a noise at level in a range of 50 to 140 decibel (dB) and at frequencies in a range of 1 to 2,500 hertz (Hz).

In this preferred embodiment, the at least one sensor 101 is a dedicated acoustic sensor, such as a microphone, but not limited to, one of the type described as a low-noise high SPL MEMS (Sound Pressure Level Micro-Electro-Mechanical System) microphone. One such exemplary microphone is the ICS-40300 manufactured by TDK InvenSense. This preferred microphone type for the at least one sensor 101 is selected for resolution, cost, size, and power consumption, wherein this preferred sensor type for the at least one sensor 101 has a resolution of 0.015 Pa, a power consumption of 0.25 mA, and has a reasonable cost for integration within the TPMS unit sensor 3 of the TPMS system. This preferred at least one sensor 101 is placed directly on the circuit board 30 and within the tire 2 in a coupling with the TPMS unit sensor 3 and positioned and aligned directionally within the interior space towards an interior underside tread portion of the tire 2 within this interior space.

Accordingly, to facilitate this alignment and positioning on the TPMS unit sensor 3 in this preferred embodiment, the at least one sensor 101 is placed upon the circuit board 30 and aligned such that a receiving/sensing portion of the at least one sensor 101 is positioned adjacent to the interior of the tire 2 for detecting a noise signal within this interior tire 2 space. This position allows the at least one sensor 101 to be directed towards the interior underside of the tire tread portion for better detection and measurement of noise within the interior space or cavity of the tire 2 interior.

In this preferred embodiment, the at least one sensor 101 placement within the existing TPMS unit sensor 3 assembly within the tire 2 requires a small aperture 310 in a cover 31 or case portion of the TPMS unit sensor 3 positioned on the interior surface on the wheel 1. The small aperture 310 is placed in directional alignment with the at least one sensor 101 placement on the circuit board 30 and is generally configured to allow for the transmission of acoustic waves from the interior tire 2 space to an interior space within the cover 31 or case portion for detection and measurement by the at least one sensor 101. Accordingly, the small aperture 310 must be through the cover 31 portion and generally directionally aligned towards the inner surface of the tire 2 tread portion within the interior. The positioning of the small aperture 310 and at least one sensor 101 allows for the more efficient detection of radial acoustic waves within the tire interior cavity space. Therefore, the position of the at least one sensor 101 detector portion is to be directly aligned on the circuit board 30 with the small aperture 310 to allow for this acoustic transmission.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of the specification.

What is claimed is:

1. A tire pressure monitoring system, the tire pressure monitoring system including a tire pressure monitoring system unit sensor within an interior space of a tire adapted to sense a pressure of the tire mounted on a wheel and in communication with a vehicle, the tire pressure monitoring system unit sensor comprising:
at least one acoustic sensor, the at least one acoustic sensor being a microphone coupled to the tire pressure monitoring system unit sensor and configured to detect an acoustic signal within an interior of the tire in the form of an audible noise of the tire and generated by the tire as the tire contacts a road surface.

2. The system as in claim 1, wherein the at least one acoustic sensor is a microphone of the low-noise high SPL MEMS (Sound Pressure Level Micro-Electro-Mechanical System) type.

3. The system as in claim 1, wherein the tire pressure monitoring system unit sensor includes a case, the case having an aperture, the aperture positioned in alignment with a detecting portion of the at least one acoustic sensor.

4. The system as in claim 1, wherein the at least one acoustic sensor is positioned directly on a circuit board of the tire pressure monitoring system unit sensor.

5. The system as in claim 1, wherein the tire pressure monitoring system includes a controller, the controller coupled to both the at least one acoustic sensor and the tire pressure monitoring system unit sensor and configured to process a detected sensor data stream for transmission to the vehicle through a transmitter.

6. The system as in claim 5, wherein the acoustic signal of the at least one acoustic sensor is used to determine a condition of the tire comprising the group of at least one of detecting the depth of a tread on the tire, detecting the overall health of the tire, and detecting the characterization of a given road condition contacted by the tire during use.

7. A tire pressure monitoring system coupled to a vehicle and configured to detect a pressure of a tire mounted on the vehicle with a tire pressure monitoring unit sensor positioned in a coupling with a valve stem within an interior of the tire, the tire pressure monitoring system unit sensor comprising:
at least one acoustic sensor, the at least one acoustic senor being a microphone coupled to the tire pressure monitoring system unit sensor and configured to detect an audible noise within an interior of the tire during operation of the vehicle as the tire contacts a road surface; and
a controller, the controller coupled to the tire pressure monitoring system, the tire pressure monitoring system unit sensor, the at least one acoustic sensor and configured to process a detected at least one acoustic sensor data stream for transmission to the vehicle through a transmitter.

8. The system as in claim 7, wherein the at least one acoustic sensor is a microphone of the low-noise high SPL MEMS (Sound Pressure Level Micro-Electro-Mechanical System) type.

9. The system as in claim 7, wherein the tire pressure monitoring system unit sensor includes a case, the case having an aperture, the aperture positioned in alignment with a detecting portion of the at least one acoustic sensor.

10. The system as in claim 7, wherein the at least one acoustic sensor is positioned directly on a circuit board of the tire pressure monitoring system unit sensor.

11. The system as in claim 7, wherein the detected acoustic signal of the at least one acoustic sensor is used to determine a condition of the tire comprising the group of at least one of detecting a depth of a tread on the tire, detecting the health of the tire, and detecting the characterization of a given road condition contacted by the tire during use.

12. The system as in claim 7, wherein the at least one acoustic sensor is configured to detect audible noise at a range between one hertz (1 Hz) and two thousand five-hundred hertz (2,500 Hz) within an interior of the tire.

13. The system as in claim 7, wherein the at least one acoustic sensor is configured to detect audible noise at a range between one hertz (1 Hz) and two thousand five-hundred hertz (2,500 Hz) within an interior of the tire during accelerating, decelerating, and constant vehicle speeds at a range from 0 to 80 miles per hour.

14. A method for detecting a tire condition with a tire pressure monitoring system in a vehicle using a tire pressure monitoring system unit sensor pressure sensor positioned in a coupling with a valve stem of the tire within an interior of the tire, the method comprising the steps of:
detecting a noise of the tire from a position at an interior of the tire with at least one acoustic sensor, the at least one acoustic sensor being a microphone configured to detect audible noise in a range between one hertz (1 Hz) and two thousand five-hundred hertz (2,500 Hz);
measuring the detected noise;
determining if the measured audible noise is at a frequency corresponding to a predetermined condition; and
transmitting the predetermined condition to a warning system of the vehicle.
